(19) United States
(12) Patent Application Publication
(10) Pub. No.: US 2007/0215439 A1
(43) Pub. Date: Sep. 20, 2007

(54) Forward Acting Turnover Apparatus and Method

(76) Inventors: Richard W. Kauppila, Negaunee, MI (US); Daniel L. Hintsala, Negaunee, MI (US)

Correspondence Address: JOHN R. BENEFIEL, 280 DAINES ST., #100 B, BIRMINGHAM, MI, 48009, US

(21) Appl. No.: 11/616,137

(22) Filed: Dec. 26, 2006

Related U.S. Application Data
(63) Continuation-in-part of application No. 10/728,183, filed on Dec. 4, 2003, now Pat. No. 7,153,086.

(51) Int. Cl. B65G 47/248

(52) U.S. Cl. 198/404

(57) ABSTRACT

A turnover apparatus and method for turning over articles such as lumber or board pieces being conveyed sideways on one or more conveyor drive loops in which each piece is retarded on the conveyor loops by structure engaging the underside of the pieces to shift the piece back against a lug mounted on each respective conveyor chain loop, the piece thereafter rotated up to an on edge position by flipper arms also mounted on the conveyor loops which each engage a cam ramp at a turnover station, the piece thereafter tipped over forwardly to complete the turnover. Optional pivoted let down arms may be arranged to engage the leading side of the pieces to controllably lower the same by motion induced by second cams at the turnover station.

### CROSS REFERENCE TO RELATED APPLICATION

This application is a continuation-in-part of U.S. Ser. No. 10/728,183 filed on Dec. 4, 2003, now U.S. Pat. No. 7,153,086

### BACKGROUND OF THE INVENTION

In various processing applications, it is sometimes necessary to turn over work pieces being moved along a conveyor system, such as to inspect both sides of lumber pieces in a saw mill being transported past an inspection station. Such processes are often conducted at high rates so that the turnover or flipping mechanism must also be reliably capable of operating at a high rate of speed. Since these mechanisms usually are synchronized with the conveyor, this becomes more difficult at these higher speeds.

In U.S. Pat. No. 7,153,086 referenced above, there is described an apparatus and method which avoids the need for such synchronization by mounting a series of flipper arms to the conveyor drive elements, i.e. the chain or belt loops, etc. That patent is hereby incorporated by reference. In the described and claimed apparatus and method, one or more auxiliary “speed up” conveyors advance the pieces loaded onto the conveyor forwardly against lugs mounted to the conveyor drive elements to properly locate the pieces in position against the lugs prior to the turnover operation. The speed up conveyors also provide a tipover push to the pieces which have been set on edge by the flipper arms to complete the turnover. This push is in a rearward direction in that apparatus.

The need for one or more “speed up” conveyors complicates the apparatus and it would be advantageous if the same method could be practiced without such a speed up conveyor.

It is an object of the present invention to provide a turnover apparatus of the type described which does not require either a speed up conveyor or synchronization between the conveyor and the turnover mechanism to simplify the apparatus and method while being capable of reliably operating at high speeds.

### SUMMARY OF THE INVENTION

The above recited object and other objects which will be understood upon a reading of the following specification and claims are achieved by providing a forward flipping action of the pieces in those applications in which forward flipping is practical. This is accomplished by stationary drag structure located to engage the conveyed pieces and retard the forward movement thereof until engaged by sets of lugs on the conveyor drive elements, i.e., chains, belts, etc., to locate each piece against a set of lugs in preparation for the turn over operation.

Sets of flipper arms are pivotally mounted to the conveyor drive elements at spaced intervals corresponding to the lug spacing, which arms are successively operated by engagement with stationary cams at a turnover station along the conveyor. The flipper arms when operated engage the trailing side of each piece which are located to extend forwardly from the lug and raise the piece to an on edge position. Since the drag structure causes the now on edge piece to be urged back against the forwardly projecting arms in the set, the top of the on edge piece is tipped forwardly to cause the piece to fall in a forward direction, thereby completing the turnover process.

Optionally, let down arms can also be employed which are raised by associated cams to engage the forward side of each of the on edge pieces and are thereafter retracted at a controlled rate to control the tip over forward motion of the pieces after engagement with the flipper arm feature.

### DESCRIPTION OF THE DRAWINGS

FIG. 1 is a pictorial fragmentary view of an apparatus according to the invention including a conveyor and a forward operating turnover mechanism, with a series of conveyed pieces shown in various stages of being turned over.

FIG. 2 is a side elevational view of the apparatus shown in FIG. 1.

FIG. 3 is an enlarged view of the area within Circle “3” in FIG. 2.

FIG. 4 is an end view of the apparatus shown in FIGS. 1 and 2.

FIG. 5 is a pictorial view of a modified form of the apparatus shown in FIG. 1.

FIG. 6A is an enlarged side elevational view of a position of the apparatus shown in FIGS. 1 and 2 with one of the conveyed pieces in position extending forwardly from a lug preparatory to being raised by a flipper arm, shown in an at rest position, with an optional let down arm also shown in broken lines.

FIG. 6B is the same view as FIGS. 6A but with the flipper arm shown in a partially raised position.

FIG. 6C is the same view as FIGS. 6A and 6B but with the flipper and let down arms both shown in a fully raised condition.

FIG. 6D is the same view as FIGS. 6A-6C but with both the flipper and let down arms partially lowered.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

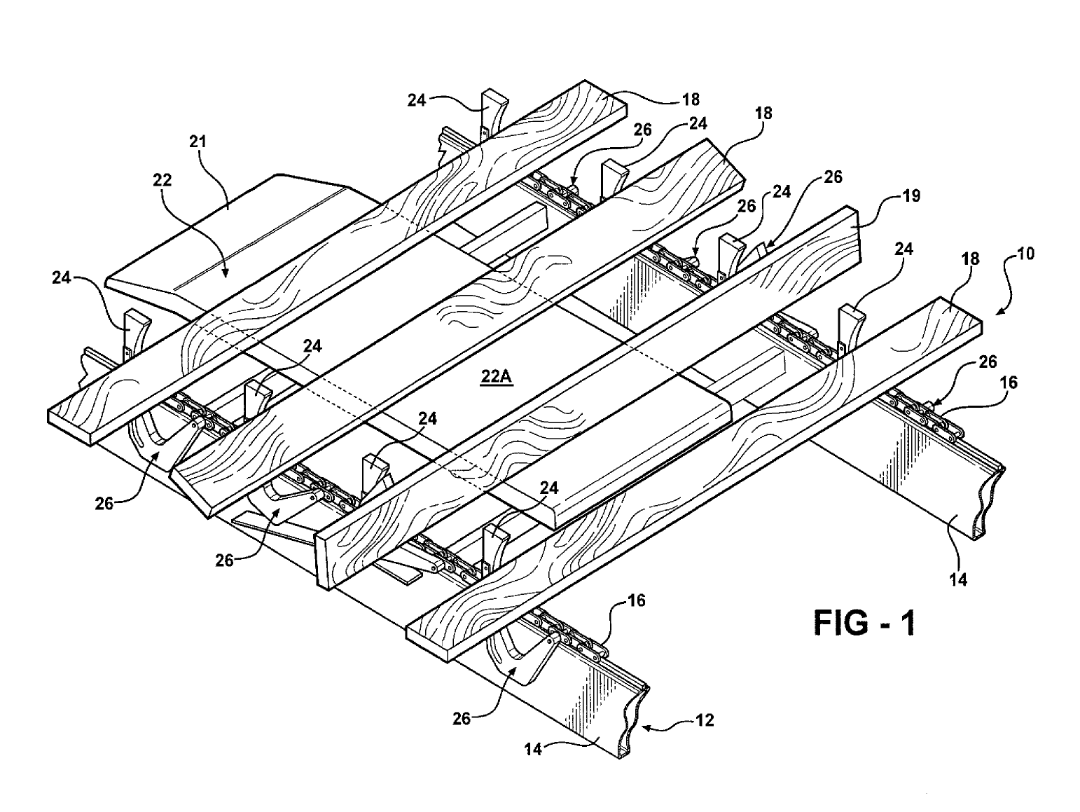

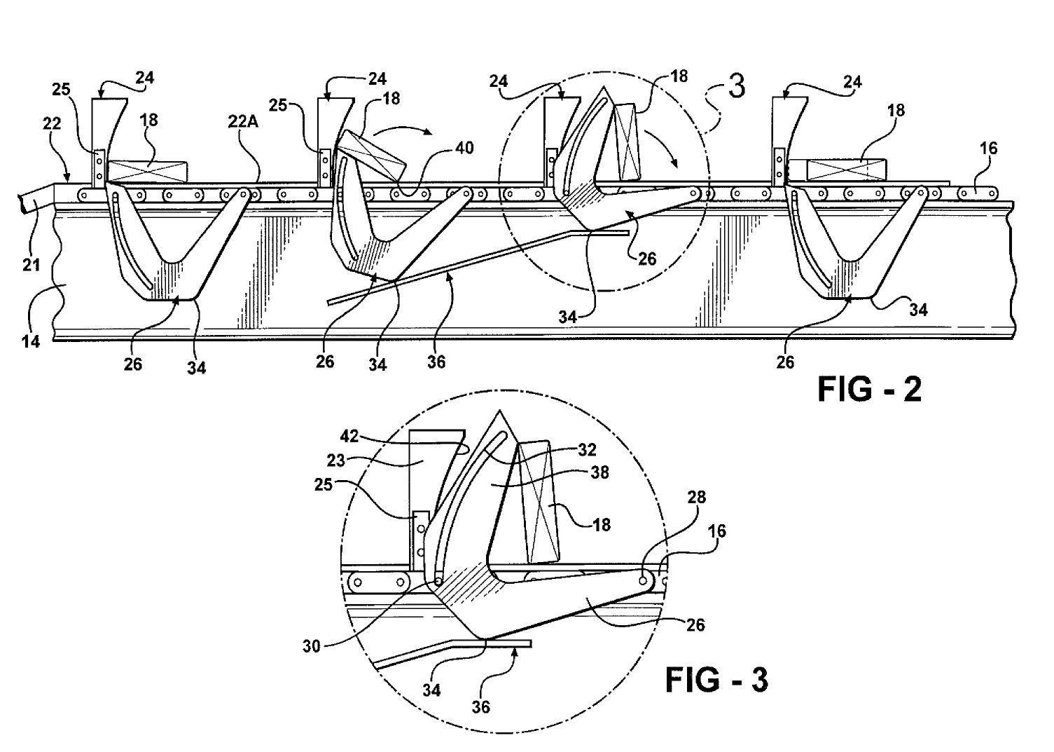

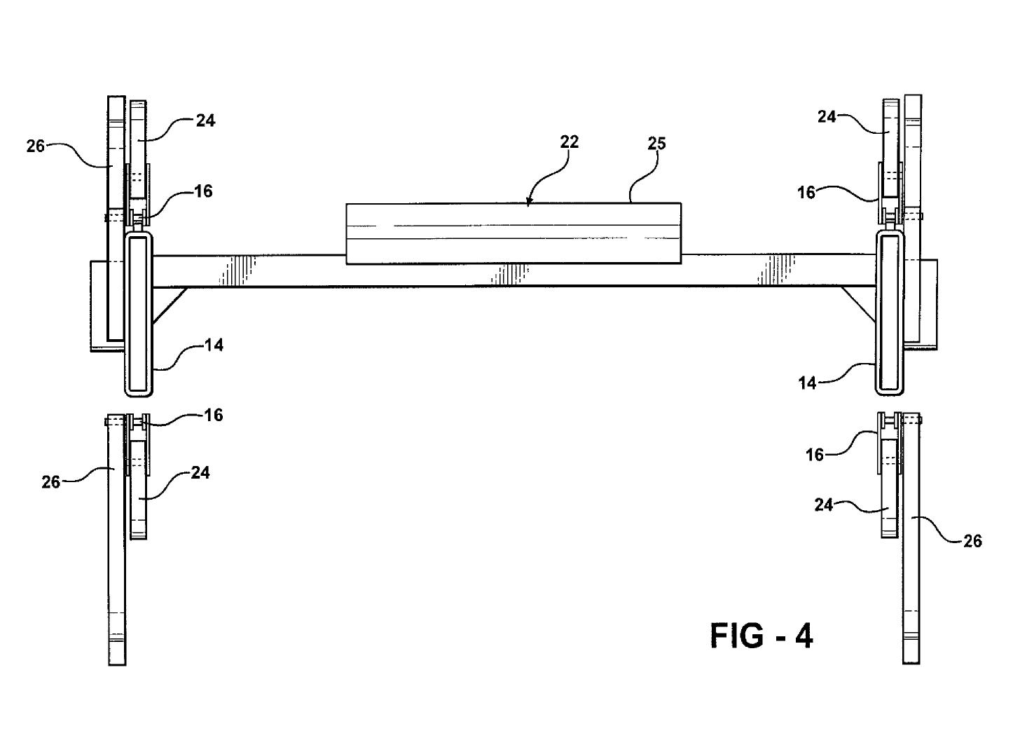

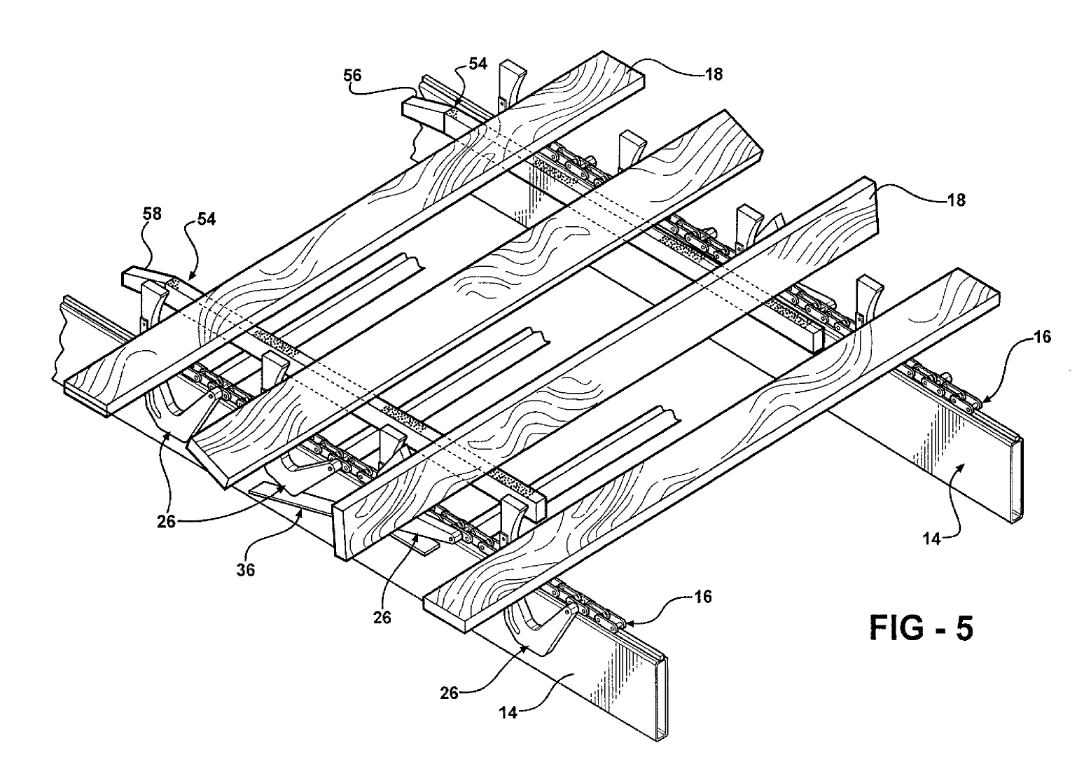

Referring to the drawings, and particularly FIGS. 1 and 2, an apparatus 10 according to the present invention includes a conveyor 12 a section of which is shown in FIG. 1 here comprised of a series of parallel support rails 14 and conveyor drive elements supported and guided thereon, here comprised of recirculating chain loops 16 designed to frictionally engage the underside of a series of articles or pieces 18 to be conveyed sideways. While boards 18 are shown the pieces 18 could be a variety of items, such as panels, doors, etc. The board pieces 18 are loaded onto the conveyor 12 at a loading station (not shown), and supported and advanced sideways on the upper surface of the chain loops 16 in the conventional manner. Such boards are typically inspected on both sides for grading and thus need to be flipped over at a grading station defined at the conveyor section shown in FIG. 1.

According to the concept of the present invention, a stationary drag structure such as the drag plate 22 shown is provided extending lengthwise along rails 14, the drag plate 22 having a sloping entry 23 at a height such as to cause each piece 18 to be elevated off the rails 14 and chain loops 16 and to be supported on the upper surface 22A of the drag plate 22 as the piece 18 is conveyed forward.

The surface 22A is located above the uppermost surfaces of the chain loops 18 so that the pieces 18 no longer touch nor are directly engaged by the conveyor drive element 16 when resting on the surface 22A.

Thus, the chain loops 16 extend beneath the pieces 18 when on the plate 22.

Each chain loop 16 has a series of spaced apart lugs 24 which are located aligned with the lugs 24 on the other chain loops 16 so as to create sets of laterally aligned lugs 24 which together engage a single piece 18 to advance the same. It is noted that such conveyors may include more than two chain loops, depending on the length of the pieces 18 to be conveyed.

The lugs 24 may be formed by a pair of metal plates 25 affixed to the chain links and a sandwiched contoured block 23 of UHMN plastic as described in U.S. Pat. No. 7,153,086.

The lugs 24 in each set thereafter engage the board pieces 18 to continue to advance the same along the rails 14 and sliding on the drag plate surface 22A to bring the same into the inspection/turnover station.

Each chain loop 16 also has a series of spaced apart flipper arms 26 which are aligned with the flipper arms 26 on the other chain loops 16 to create laterally aligned sets of arms which simultaneously act on each of the board pieces 18.

The flipper arms 26 are each pivotally connected at one end to the respective chain loop 16 by a pin 28 welded or otherwise attached to a chain link.

The flipper arms 26 are each kept from completely pivoting down at their other end by a second pin 30 engaging an arcuate slot 32 which allows upward pivoting but restrains downward pivoting any further than what is shown in FIG. 2.

The flipper arms 26 are angled to create a lower knee cam surface 34 disposed to engage a stationary cam surface here defined by a cam ramp 36 fixedly attached to a respective rail 14. An adjustability of its inclination can be provided for as described in U.S. Pat. No. 7,153,086.

As the chain loops 16 carry the flipper arms 26 past the ramps 36, engagement of cam surface 34 causes a flipper arm left portion 38 to be elevated, with the end face 39 engaging the undersurface of the trailing side of a piece 18 abutted against the associated lugs 24 to pivot the same up about a point defined by the leading lower corner 40 of the piece 18.

The lugs 24 each have a concavely curved forward facing surface 42 which accommodates the pivoting up of the pieces 18 while engaging the trailing side of the pieces 18 to restrain the pieces 18 from being driven over the top of the flipper arm left portion 38 until the left portion 38 has been raised sufficiently to prevent this.

After a piece 18 is set on edge, the drag on its undersurface created by the plate surface 22A causes the piece 18 to be tipped forwardly by the contact with the forwarding projecting edge of the flipper left portion 38 as the chain loop 16 continues to advance the flipper arm 26.

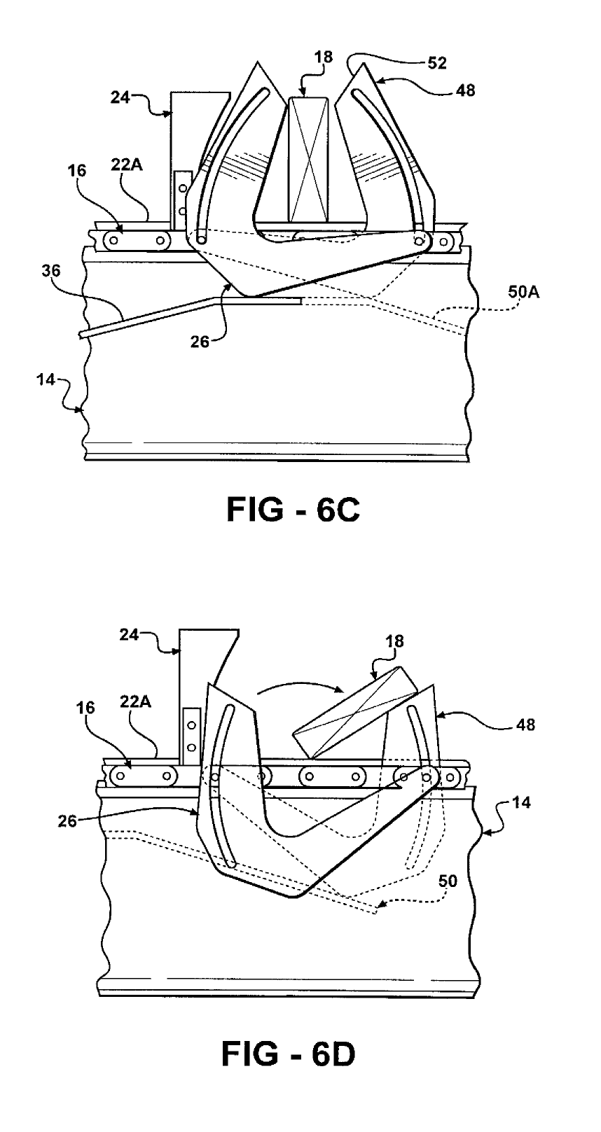

Also shown in FIGS. 6A-6D is an optional let down arm 48, a series of which are attached to each chain loop 16, in similar fashion to the flipper arms 26 but with a pivot pin at the trailing end with the leading end guided with a pin and slot arrangement. The let down arms 48 on each chain loop 16 are aligned with each other to create sets thereof also in similar fashion to the flipper arms 26. A fixed cam ramp 50 is also provided for each let down arm 48 in order to raise the same as the flipper arms 26 are raised as seen in FIG. 6C. The let down arms 48 and cam ramps 50 are mounted on the other side of the rails 14 from the flipper arms 26 and cam ramps 36.

After the piece 18 is tipped forwardly, contact is made with the end face 52 of the let down arms 48 in an associated set. The cam ramps 50 each have a descending portion 50A which controllably lowers the associated let down arms 48 to prevent too rapid falling forward of the pieces 18 where this could damage the pieces 18, as where heavy or delicate pieces are involved.

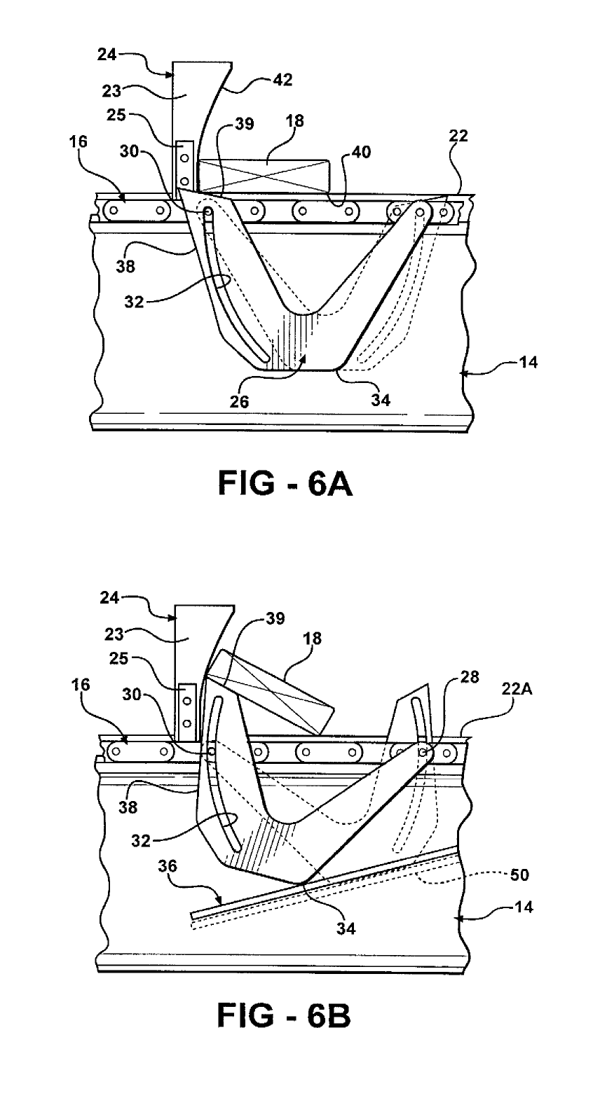

FIG. 5 shows an alternate form of the drag structure comprised of a pair of widely spaced horizontal bars 54, which can be supported on the inside of the rails 14, or alternatively directly attached to the inside of the side rails 14 as shown at the tope in FIG. 5 with an entrance ramp 56 at the leading end. This arrangement minimizes the chances that the pieces 18 will be skewed, since they are contacted at widely spaced points along their length.

It is noted that the forward turnover action described shifts the piece position, i.e. the turnover is not “in place”. Some manual inspectors prefer an in place turnover, and the backwards flipping described in U.S. Pat. No. 7,153,086 provides this. Automated inspections or other applications can employ the simpler forward flipping turnover motion provided by the present invention.

1. A turnover apparatus for turning over pieces conveyed sideways on one or more recirculating conveyor loops by frictional engagement therewith, comprising:
a series of spaced apart lugs attached along each of said conveyor loops and projecting above an upper surface of said conveyor loops to be able to be engaged by articles being advanced on said upper surface of said conveyor loops;
a series of flipper arms pivotally mounted to at least one of said one or more conveyor loops to be carried along with said recirculating conveyor loops, said flipper arms pivotably mounted at a pivot point adjacent a respective associated lug so that said pivot point has a fixed relative position with respect to said associated lug, said flipper arms each having one portion able to engage and lift a portion of an article after being driven against an associated lug by said drag structure when said flipper arm portion is pivoted up from a normally retracted position below said conveyor loop surface;
a stationary cam adjacent to each conveyor loop having a series of flipper arms mounted thereto and located at said turnover station positioned to engage another portion of each flipper arm as said conveyor loops carry each flipper arm past said stationary cam ramp to cause said one portion of each of said flipper arms to be successively pivoted into engagement with said article located above said one portion to rotate said article to on an edge position, each on edge piece tipped forwardly by continued engagement with a flipper arm and retarding thereof relative said conveyor drive element effected by said drag structure.

2. The apparatus according to claim 1 wherein each of said flipper arms has a first and a second portion, each portion extending at an angle to the other portion, a free end of said first segment normally downwardly extending and pivotally mounted on a conveyor loop.

3. The apparatus according to claim 2 wherein each flipper arm second portion extends upwardly to form a knee at the intersection of said first and second portion, said knee engaging said stationary cam to cause upward pivoting of each flipper arm when moving past said cam.

4. The apparatus according to claim 3 further including an arcuate guide slot formed in said second portion of each flipper arm and a guide pin extending from an associated chain link of an associated chain link conveyor loop into said guide slot.

5. The apparatus according to claim 1 further including a series of let down arms pivotally mounted on said conveyor loop, each element located adjacent a respective flipper arm, and a second stationary cam associated with each of said let down arms when advancing through said turnover station for initially raise an associated let down arm and thereafter lower the same, each turnover arm having a portion engaging a forward side of a piece raised to an on edge position by a flipper arm.

6. A method of turning over pieces at a turnover station along a conveyor including one or more conveyor loops supporting and frictionally engaging said pieces positioned on said conveyor loops to convey the same, including
mounting a series of spaced apart lugs to each conveyor loop, said lugs each having a portion projecting above said conveyor loops;
loading each piece into aligned spaces between successive lugs to be carried along on said conveyor loops;
pivotally mounting a series of flipper arms to at least one of said one or more conveyor loops to be carried along with said conveyor loop to which said flipper arms are pivotably mounted, said flipper arms pivotably mounted at a point adjacent a respective associated lug so that said point has a fixed position with respect to said associated lug, each flipper arm having an engagement portion normally positioned below a forward side of each lug;
retarding each piece on said one or more conveyor loops to be shifted back into abutment with a trailing lug;
fixedly locating a cam adjacent each conveyor loop having said flipper arms pivotally mounted thereto at said turnover station so as to engage one portion of each flipper arm moving into said turnover station as an piece is moved through said turnover station and past said cam, each cam configured to cause an upward movement of an associated flipper arm from a normally retracted position to engage an engagement portion of each of said flipper arms with a trailing side of a piece abutting a lug to elevate said trailing side of said piece when engaged therewith to rotate said piece to an edge position, and thereafter tipping said on edge piece forwardly to complete the turnover thereof.

7. The method according to claim 6 wherein said pieces are conveyed by two or more spaced conveyor loops and an aligned series of lugs are mounted on each conveyor loop, and a drag structure is interposed between said conveyor loops to retard a conveyed piece into abutment with an adjacent trailing lug on each conveyor loop.

8. The method according to claim 7 further including the step of engaging an upper front portion of each piece as it is tipping over from said on edge position, and controllably restraining tipping of said upper front portion of each piece to slow the rate of tipping over of said piece.

9. The method according to claim 8 further including pivotally mounting a let down cam to each of said one or more conveyor loops, locating each let down element adjacent a respective flipper arm and engaging said upper front portion of a piece while engaging each let down arm with a second cam to control descent thereof as said piece tips over

10. Apparatus for flipping over pieces on a conveyor loop drive member having an upper surface frictionally engaging said pieces resting thereon to convey said pieces by advance of said conveyor loop, comprising a series of spaced apart lugs mounted to said conveyor loop drive member defining intervening spaces able to receive a piece to be turned over;
a series of flipper elements pivotally mounted to said conveyor loop drive member to be carries along therewith as said member is advanced, each flipper element located adjacent an associated lug and pivotable at a fixed relative position with respect to said associate lug to raise a first portion of each flipper element from a lowered retracted position into engagement with a trailing side of a piece abutting an associated lug;
a cam surface mounted at a turnover station to engage each flipper element moved past said turnover station by said loop conveyor drive member, said cam surface causing pivoting raising motion of each flipper element from a retracted lowered position, said pivoting raising motion of each flipper element setting on edge a piece located adjacent a respective lug on said loop conveyor drive member and thereafter tipping said piece forwardly.

11. An apparatus according to claim 10 further including a drag structure engaging each piece to retard the same to bring said piece into a position against the next trailing lug when in said turnover station.

12. An apparatus according to claim 1 further including a let down element pivotally mounted on said conveyor loop drive member adjacent each flipper element, a second cam having an entrance segment engaging and pivoting up said let down element in said turnover station to engage on upper portion of said piece set on edge by said engagement with said flipper element, said second cam surface having an exit segment engaging said let down element to allow a controlled descent said piece as said piece tips over to insure a slowed rate of tipping to avoid damage thereto.
